(19) United States
(12) Patent Application Publication
(10) Pub. No.: US 2025/0076795 A1
(43) Pub. Date: Mar. 6, 2025

(54) FIXING DEVICE AND IMAGE FORMING DEVICE

(71) Applicant: TOSHIBA TEC KABUSHIKI KAISHA, Tokyo (JP)

(72) Inventor: Reo Kawaguchi, Mishima Shizuoka (JP)

(21) Appl. No.: 18/461,653

(22) Filed: Sep. 6, 2023

(51) Int. Cl. G03G 15/20

(52) U.S. Cl. CPC G03G 15/2039

(57) ABSTRACT

According to one embodiment, a fixing device includes a first roller, a second roller, and a sensor unit. The first roller is rotatable around a first rotation axis. The second roller is rotatable around a second rotation axis. The second roller can contact and separate from the first roller. The second roller can contact the first roller to form a nip. The distance between the first rotation axis and the second rotation axis is a first distance. The sensor unit can output a signal corresponding to the first distance which is continuously changing.

### FIELD

Embodiments described herein relate generally to a fixing device and an image forming device.

### BACKGROUND

An image forming device includes an image forming part that forms an image and a fixing device that fixes the image onto a sheet. There is a demand for a fixing device and an image forming device capable of improving image fixing quality.

### DESCRIPTION OF THE DRAWINGS

FIG. 1 is a schematic configuration diagram of an image forming device according to an embodiment;

FIG. 2 is a hardware configuration diagram of the image forming device;

FIG. 3 is a front cross-sectional view of a pressure roller and a heating roller of a fixing device;

FIG. 4 is a schematic configuration diagram of the fixing device according to the embodiment;

FIG. 5 is an explanatory diagram of an operation of the fixing device;

FIG. 6 is a perspective view of a sensor unit;

FIG. 7 is a graph showing a relationship between a rotation angle of a first gear and a movement distance of a second rotation axis; and

FIG. 8 is a schematic configuration diagram of the fixing device in a modification of the embodiment.

### DETAILED DESCRIPTION

In general, according to one embodiment, a fixing device includes a first roller, a second roller, and a sensor unit. The first roller is rotatable around a first rotation axis. The second roller is rotatable around a second rotation axis. The second roller can contact and separate from the first roller. The second roller can contact the first roller to form a nip. The distance between the first rotation axis and the second rotation axis is a first distance. The sensor unit can output a signal corresponding to the first distance which is continuously changing.

Hereinafter, a fixing device and an image forming device according to an embodiment will be described below with reference to the drawings.

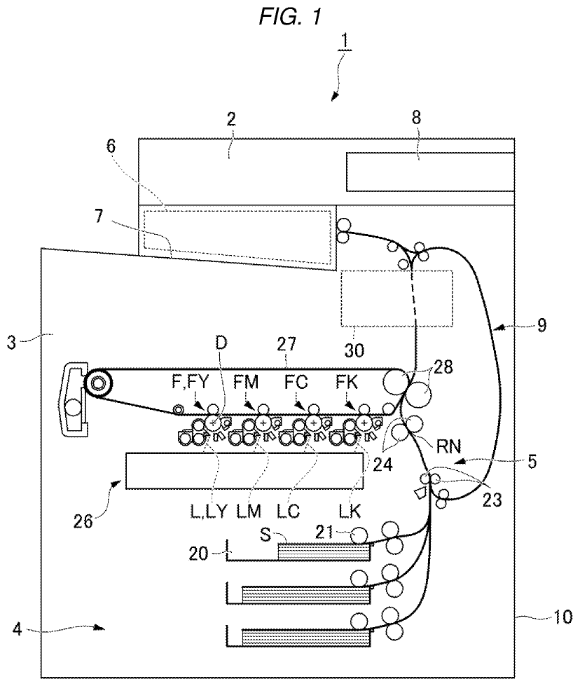

FIG. 1 is a schematic configuration diagram of an image forming device 1 according to the embodiment.

The image forming device 1 performs processes for forming an image on a sheet S. The sheet may be paper. The image forming device 1 includes a housing 10, a scanner unit 2, an image forming unit 3, a sheet feeding unit 4, a conveying unit 5, a tray 7, a reversing unit 9, a control panel 8, and a control unit 6.

The housing 10 forms an outer appearance of the image forming device 1.

The scanner unit 2 reads image information of an object to be copied based on brightness and darkness of light and generates an image signal. The scanner unit 2 outputs the generated image signal to the image forming unit 3.

The image forming unit 3 forms a toner image based on the image signal from the scanner unit 2 or from the outside. The toner image is an image formed with toner or other material. The image forming unit 3 transfers the toner image onto a surface of the sheet S. The image forming unit 3 heats and presses the toner image on the surface of the sheet S to fix the toner image onto the sheet S.

The sheet feeding unit 4 feeds the sheets S one by one to the conveying unit 5 according to the timing of forming toner image by the image forming unit 3. The sheet feeding unit 4 has a sheet storage unit 20 and a pickup roller 21.

The sheet storage unit 20 stores sheets S of a predetermined size and type.

The pickup roller 21 picks up the sheets S one by one from the sheet storage unit 20. The pickup roller 21 feeds the picked sheet S to the conveying unit 5.

The conveying unit 5 conveys the sheet S fed from the sheet feeding unit 4 to the image forming unit 3. The conveying unit 5 includes a conveying roller 23 and a registration roller 24.

The conveying roller 23 conveys the sheet S fed from the pickup roller 21 to the registration roller 24. The conveying roller 23 causes the leading end of the sheet S in the conveying direction to abut against a nip RN of the registration roller 24.

The registration roller 24 adjusts the position of the leading end of the sheet S in the conveying direction by bending the sheet S at the nip RN. The registration roller 24 conveys the sheet S according to the timing of transferring the toner image onto the sheet S by the image forming unit 3.

The image forming unit 3 will be described.

The image forming unit 3 includes a plurality of image forming parts F, a laser scanning unit 26, an intermediate transfer belt 27, a transfer part 28, and a fixing device 30.

The image forming part F includes a photosensitive drum D. The image forming part F forms a toner image on the photosensitive drum D in accordance with image signals. A plurality of image forming parts FY, FM, FC, and FK form toner images with the yellow, magenta, cyan, and black toners, respectively.

The charging device charges the surface of the photosensitive drum D. The developing device accommodates a developer including yellow, magenta, cyan, and black toners. The developing device develops an electrostatic latent image on the photosensitive drum D so as to form a toner image of each color on the photosensitive drum D.

The laser scanning unit 26 scans the charged photosensitive drum D with a laser beam L to expose the photosensitive drum D. The laser scanning unit 26 exposes respective laser beams LY, LM, LC, and LK so as to form electrostatic latent images on photosensitive drums D of the image forming parts FY, FM, FC, and FK of respective colors.

The toner image on the surface of the photosensitive drum D is primarily transferred onto the intermediate transfer belt 27.

The transfer part 28 in the secondary transfer position transfers the toner image, which is primarily transferred onto the intermediate transfer belt 27, onto the surface of the sheet S.

The fixing device 30 performs a fixing process on the sheet S. The fixing process is a process of heating and pressurizing the transferred toner image on the sheet S so as to fix the toner image onto the sheet S. The fixing device 30 will be described below in detail.

The reversing unit 9 reverses the sheet S to form an image on the back side of the sheet S. The reversing unit 9 reverses, by switchback, the front and back sides of the sheet S ejected from the fixing device 30. The reversing unit 9 conveys the reversed sheet S toward the registration roller 24.

The tray 7 holds the ejected sheets S having an image formed thereon.

The control panel 8 is a part of input part through which an operator inputs information for operating the image forming device 1. The control panel 8 may have a touch panel or various hard keys.

The control unit 6 controls the respective parts of the image forming device 1.

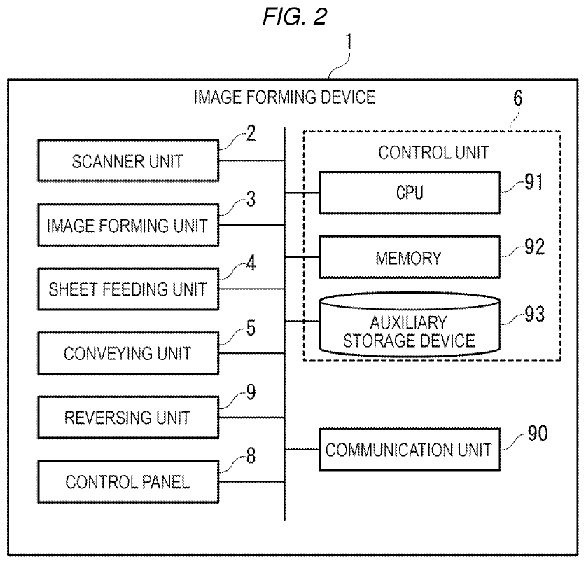

FIG. 2 is a hardware configuration diagram of the image forming device. The image forming device 1 includes a Central Processing Unit (CPU) 91 connected via a bus, a memory 92, an auxiliary storage device 93, and the like, and executes a program. By the execution of the program, the image forming device 1 functions as a device including the scanner unit 2, the image forming unit 3, the sheet feeding unit 4, the conveying unit 5, the reversing unit 9, the control panel 8, and a communication unit 90.

The CPU 91 functions as the control unit 6 by executing the programs stored in the memory 92 and the auxiliary storage device 93. The control unit 6 controls the operation of each functional unit of the image forming device 1. The control unit 6 controls the operation of the fixing device 30.

The auxiliary storage device 93 includes a storage device such as a magnetic hard disk device or a semiconductor storage device. The auxiliary storage device 93 stores information.

The communication unit 90 includes a communication interface for connecting its device to an external device. The communication unit 90 communicates with an external device via a communication interface.

The fixing device 30 will be described in detail.

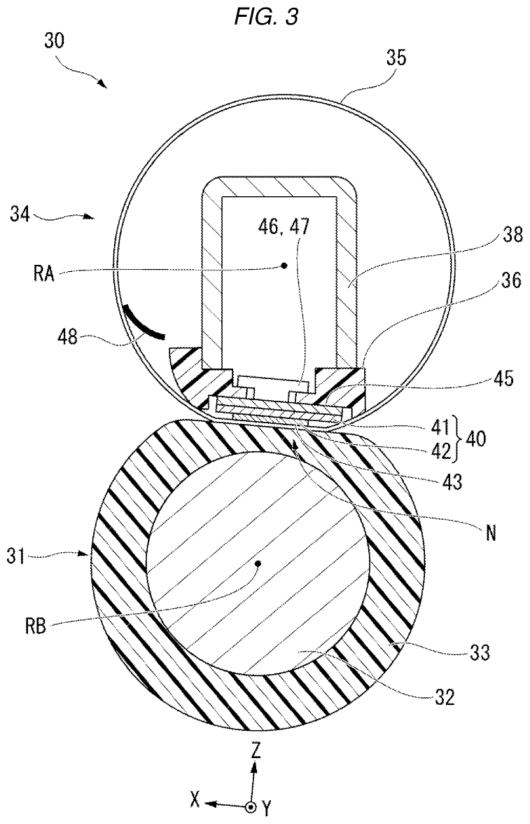

FIG. 3 is a front cross-sectional view of a pressure roller 31 and a heating roller 34 of the fixing device. The fixing device 30 includes the pressure roller 31 (second roller) and the heating roller 34 (first roller). The pressure roller 31 can contact the heating roller 34 to form a nip N. In the application, the definitions of Z, X and Y directions herein are as follows. Z direction is a direction along which the heating roller 34 and the pressure roller 31 are aligned. +Z direction is a direction from the pressure roller 31 toward the heating roller 34. X direction is a direction along which the sheet S is conveyed in the nip N. Y direction is an axial direction of a first rotation axis RA of the heating roller 34 and a second rotation axis RB of the pressure roller 31.

The pressure roller 31 presses the toner image onto the sheet S entering the nip N. The pressure roller 31 includes a core metal 32 and an elastic layer 33. The pressure roller 31 is not limited to the configuration described above, and can have various configurations.

The core metal 32 is formed of a metal material such as stainless steel and the like in a columnar shape. The elastic layer 33 is formed of an elastic material such as silicone rubber and the like. The elastic layer 33 has a constant thickness on an outer circumferential surface of the core metal 32. A release layer may be formed of a resin material such as tetrafluoroethylene-perfluoroalkyl vinyl ether copolymer (PFA) and the like and provided on an outer circumferential surface of the elastic layer 33.

The pressure roller 31 is driven by a motor and rotatable around the second rotation axis RB. When the nip N is formed and the pressure roller 31 is rotated, a tubular film 35 of the heating roller 34 is driven to rotate around the first rotation axis RA. The pressure roller 31 is rotated while the sheet S is in the nip N, thus conveying the sheet S.

The heating roller 34 heats the toner image on the sheet S entering the nip N. The heating roller 34 includes the tubular film 35 (tubular body), a heating element unit 40, a heat transfer member 45, a support member 36, a stay 38, and temperature sensitive elements 46, 47, and 48. The heating roller 34 is not limited to the configuration described above, and can have various configurations.

The tubular film 35 is cylindrical. The tubular film 35 includes a base layer, an elastic layer, and a release layer in order from the inner peripheral side. The base layer is formed of a resin material such as polyimide (PI) and the like to reduce heat capacity. The base layer may be formed of a metal material such as nickel (Ni). The elastic layer is formed of an elastic material such as silicone rubber and the like. The release layer is formed of a material such as PFA resin and the like.

The heating element unit 40 is disposed within the tubular film 35. A first surface 43 of the heating element unit 40 in the −Z direction is in contact with an inner surface of the tubular film 35 via grease. The heating element unit 40 includes a substrate 41 and a heating element 42.

The substrate 41 is formed of a metal material such as stainless steel and the like, or a ceramic material such as aluminum nitride and the like. The substrate 41 is formed in an elongated rectangular plate shape. The substrate 41 has a longitudinal direction in the Y direction and a lateral direction in the X direction.

The heating element 42 is formed of silver-palladium alloy or the like. When energized, the heating element 42 generates heat. The heating element 42 is disposed in the −Z direction of the substrate 41.

The heat transfer member 45 is made of a metal material with high thermal conductivity, such as copper. The heat transfer member 45 is in contact with the second surface of the heating element unit 40 in the +Z direction. The heat transfer member 45 is formed of a material having higher thermal conductivity than the substrate 41 of the heating element unit 40. The heat transfer member 45 equalizes the temperature distribution of the heating element unit 40 in the Y direction.

The support member 36 is formed of a resin material such as liquid crystal polymer and the like. The support member 36 is disposed to cover both sides of the heating element unit 40 in the +Z direction and the X direction. The support member 36 supports the heating element unit 40 via the heat transfer member 45 in the Z direction. The support member 36 supports the inner peripheral surface of the tubular film 35 on both sides of the heating element unit 40 in the X direction.

The stay 38 is formed of a steel plate material or the like. The stay 38 has a U-shaped cross-section perpendicular to the Y direction. The stay 38 is mounted in the +Z direction of the support member 36 such that the support member 36 closes the U-shaped opening. The stay 38 extends in the Y direction. Both ends of the stay 38 in the Y direction are fixed to the housing 10 of the image forming device 1.

The temperature sensitive elements 46, 47, and 48 are a heater thermometer 46, a thermostat 47, and a film thermometer 48. The heater thermometer 46 and the thermostat 47 are arranged in the +Z direction of the heating element unit 40. The heater thermometer 46 measures the temperature of the heating element unit 40 via the heat transfer member 45. The thermostat 47 cuts off the energization of the heating element 42 when the temperature of the heating element unit 40 exceeds a predetermined temperature.

The film thermometer 48 measures the temperature of the tubular film 35. The film thermometer 48 outputs a signal corresponding to the temperature of the tubular film 35 to the control unit 6. The control unit 6 controls energization of the heating element unit 40 to the heating element 42 based on the temperature of the tubular film 35. Accordingly, the control unit 6 controls the temperature of the nip N (hereinafter, sometimes referred to as the fixing temperature).

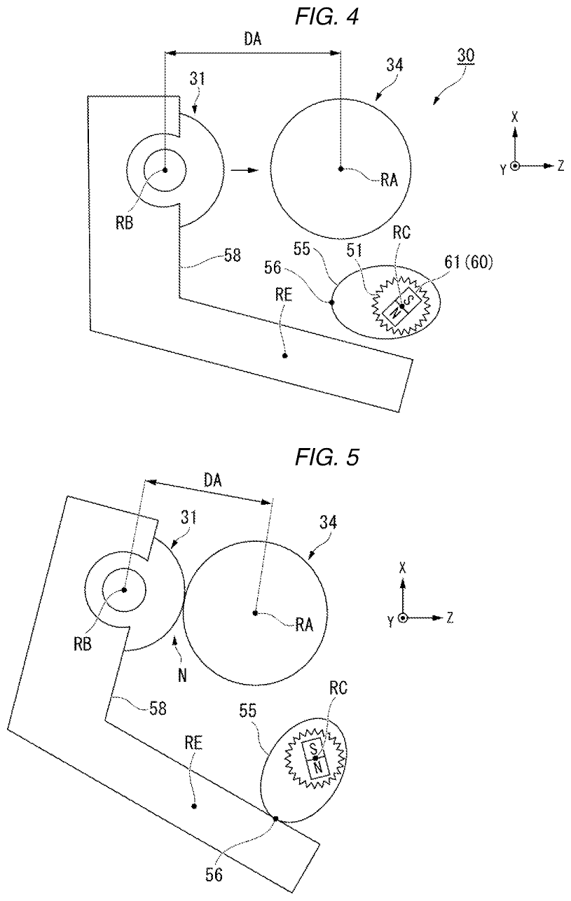

FIG. 4 is a schematic configuration diagram of the fixing device 30 in the embodiment. The fixing device 30 includes an arm 58, a cam 55, a first gear 51, and a sensor unit 60 in addition to the pressure roller 31 and the heating roller 34 described above.

The arm 58 rotatably supports the pressure roller 31. The arm 58 is rotatable around a rotation axis RE. The rotation axis RE is parallel to the Y direction. The arm 58 can be in contact with the cam 55 on the opposite side of the pressure roller 31 across the rotation axis RE. The arm 58 may include a cam follower that is in contact with the cam 55. The arm 58 is rotatable in conjunction with the rotation of the cam 55.

The cam 55 is driven to be rotated by a motor (not shown). The cam 55 is rotatable around a third rotation axis RC. The third rotation axis RC is parallel to the Y direction. The cam 55 is rotatable in an angular range of less than 360°. The distance from the third rotation axis RC to an outer circumference of the cam 55 changes continuously along the circumferential direction of the third rotation axis RC. The cam 55 has a top portion 56 on its outer circumference. The distance from the third rotation axis RC to the top portion 56 is the longest distance of the distances from the third rotation axis RC to the outer circumference of the cam 55.

FIG. 5 is an explanatory diagram of an operation of the fixing device 30. In FIG. 5, the cam 55 is in contact with the arm 58 at or near the top portion 56. The cam 55 pushes the arm 58 and the arm 58 is rotated around the rotation axis RE. The arm 58 presses the pressure roller 31 against the heating roller 34. The nip N is formed between the pressure roller 31 and the heating roller 34. The fixing device 30 heats and presses the toner image on the sheet S entering the nip N so as to fix the toner image onto the sheet S.

When the sheet S is jammed in the fixing device 30, it is necessary to remove the sheet S from the fixing device 30. For this purpose, it is necessary to separate the pressure roller 31 from the heating roller 34 as shown in FIG. 4. Further, when the fixing device 30 is in a sleep state, the pressure roller 31 is separated from the heating roller 34 in order to prevent plastic deformation of the tubular film 35. For example, the sleep state is a state in which the memory 92 is energized but the heating element unit 40 is not energized.

From FIG. 5 to FIG. 4, the cam 55 is rotated around the third rotation axis RC. The top portion 56 of the cam 55 is moved away from the arm 58. The arm 58 is rotated around the rotation axis RE by the biasing force of a biasing member (not shown) or by its own weight. As a result, the pressure roller 31 is separated from the heating roller 34.

The first gear 51 is rotatable together with the cam around the third rotation axis RC. The first gear 51 is installed in a transmission path of a rotational driving force from the motor to the cam 55. The first gear 51 may also be installed outside the transmission path of the rotational driving force. The first gear 51 is rotatable in an angular range of less than 360°.

As shown in FIG. 4, the distance between the first rotation axis RA of the heating roller 34 and the second rotation axis RB of the pressure roller 31 is the first distance DA.

The sensor unit 60 can output a signal corresponding to the first distance DA which is continuously changing. The first distance DA is changed by the rotation of the first gear 51 and the cam 55. A signal corresponding to the rotation angle of the first gear 51 is an example of the signal corresponding to the first distance DA. The sensor unit 60 outputs the signal corresponding to the rotation angle of the first gear 51.

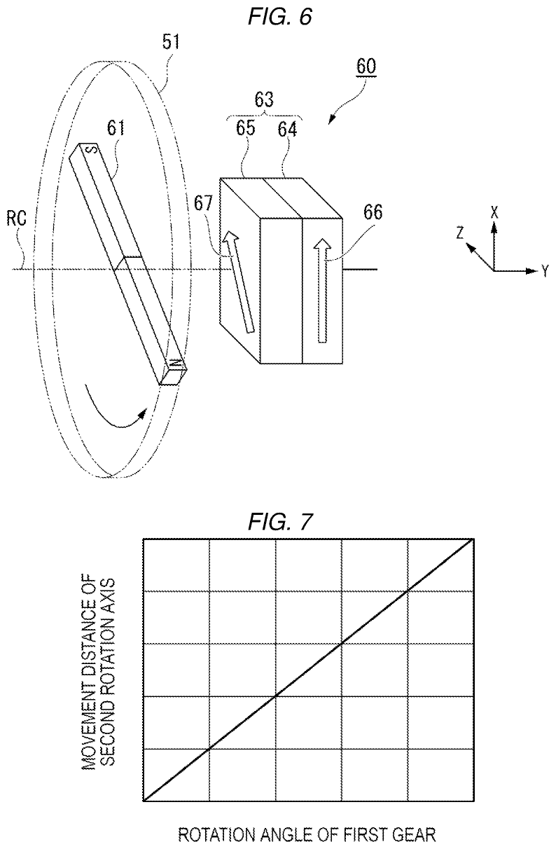

FIG. 6 is a perspective view of the sensor unit 60. The sensor unit 60 includes a magnet 61 and a tunnel magneto resistance (TMR) element 63.

The magnet 61 is rotatable together with the cam 55 around the third rotation axis RC. The magnet 61 is mounted to the first gear 51 that is rotatable together with the cam 55 around the third rotation axis RC. The magnet 61 may be mounted to the cam 55 itself which is rotatable around the third rotation axis RC. For example, the magnet 61 is a permanent magnet. The polarization direction of the magnet 61 is a direction perpendicular to the third rotation axis RC (Y direction). For example, the center of the magnet 61 in the polarization direction is located on the third rotation axis RC.

The TMR element 63 is disposed side by side with the magnet 61 in the Y direction. The TMR element 63 is disposed to cross the third rotation axis RC. The TMR element 63 includes a pinned layer 64 and a free layer 65. The pinned layer 64 and the free layer 65 are arranged side by side in the Y direction. The pinned layer 64 is away from the magnet 61 and the free layer 65 is closer to the magnet 61.

The TMR element 63 has a magnetoresistive effect, that is, the resistance value changes with an external magnetic field. The pinned layer 64 is magnetized in a first magnetization direction 66 and the free layer 65 is magnetized in a second magnetization direction 67. The first magnetization direction 66 and the second magnetization direction 67 are directions perpendicular to the Y direction. The first magnetization direction 66 is fixed. The second magnetization direction 67 changes in the circumferential direction of the third rotation axis RC. When the first magnetization direction 66 and the second magnetization direction 67 are in the same phase, the resistance value of the TMR element 63 in the Y direction (hereinafter simply referred to as “the resistance value of the TMR element 63”) is minimized. When the first magnetization direction 66 and the second magnetization direction 67 are in opposite phases, the resistance value of the TMR element 63 is maximized. The resistance value of the TMR element 63 continuously changes according to the phase difference between the first magnetization direction 66 and the second magnetization direction 67.

The TMR element 63 is an element of which tunnel magnetic resistance changes with the rotation of the magnet 61. The magnet 61 is rotated around the third rotation axis RC together with the first gear 51. By the magnetic field of the magnet 61, the second magnetization direction 67 of the TMR element 63 changes in the circumferential direction of the third rotation axis RC. The resistance value of the TMR element 63 continuously changes according to the phase difference between the first magnetization direction 66 and the second magnetization direction 67. A signal corresponding to the resistance value of the TMR element 63 is an example of the signal corresponding to the rotation angle of the first gear 51. The sensor unit 60 outputs the signal corresponding to the resistance value of the TMR element 63. As a result, the sensor unit 60 outputs a signal corresponding to the first distance DA which is continuously changing.

As shown in FIG. 4, the second rotation axis RB of the pressure roller 31 is moved in the Z direction according to the rotation of the first gear 51 and the cam 55. As a result, the first distance DA is changed.

FIG. 7 is a graph showing the relationship between the rotation angle of the first gear 51 and the movement distance of the second rotation axis RB. As the rotation angle of the first gear 51 increases, the movement distance of the second rotation axis RB increases. When the pressure roller 31 is in contact with the heating roller 34, the nip N is formed at a contact portion between both rollers. After the nip N is formed, when the movement distance of the second rotation axis RB further increases, the pressure at the nip N increases.

The control unit 6 receives the signal corresponding to the resistance value of the TMR element 63 from the sensor unit 60. The control unit 6 stores a relational expression, a table, or the like which expresses the relationship between the resistance value of the TMR element 63 and the rotation angle of the first gear 51. Using this relationship, the control unit 6 calculates the rotation angle of the first gear 51 from the resistance value of the TMR element 63. Using the relationship shown in FIG. 7, the control unit 6 obtains the movement distance of the second rotation axis RB from the rotation angle of the first gear 51. The control unit 6 stores a relational expression, a table, or the like which expresses the relationship between the movement distance of the second rotation axis RB and the pressure in the nip N. Using this relationship, the control unit 6 calculates the pressure of the nip N from the movement distance of the second rotation axis RB.

The control unit 6 controls the rotation angle of the cam 55 based on the output signal of the sensor unit 60 so as to change the first distance DA. As a result, the control unit 6 controls the pressure of the nip N (hereinafter referred to as fixing pressure). The control unit 6 changes the first distance DA and sets the fixing pressure to an appropriate value according to various conditions of the fixing process. As a result, it is possible to improve the fixing quality of the image.

The control unit 6 changes the first distance DA according to the thickness of the sheet S.

A first sheet is the sheet S having a thickness equal to or greater than a predetermined value. A second sheet is the sheet S having a thickness less than the predetermined value. The heat capacity of the first sheet is greater than that of the second sheet. As the first sheet enters the nip N, much of the amount of heat in the nip N is transferred to the first sheet. Accordingly, the amount of heat transferred to the toner on the first sheet decreases. As a result, there is a concern of insufficient melting of the toner, deteriorating the fixing quality of the image.

A user of the image forming device 1 inputs, to the control panel 8 (see FIG. 1), the type of the sheet S to form an image. The control unit 6 determines whether or not the sheet S to form an image is the first sheet. When the sheet S is the first sheet, the control unit 6 causes the first distance DA shorter than when the sheet S is the second sheet. The control unit 6 causes the cam 55 to be rotated and the pressure roller 31 to be moved in the +Z direction so that the first distance DA is shortened. As a result, the control unit 6 increases the fixing pressure.

As the fixing pressure is increased, the pressure acting on the toner on the first sheet is increased. A decrease in the amount of heat transferred to the toner on the first sheet is compensated for by an increase in the pressure acting on the toner. As a result, the toner on the first sheet is sufficiently melted, and deterioration of image fixing quality is prevented.

The deterioration of the lifespan of the fixing device 30 is prevented by increasing the fixing pressure, rather than by increasing the fixing temperature. The decrease in productivity (efficiency) of image formation is prevented by increasing the fixing pressure, rather than by extending the residence time of the first sheet in the nip N (hereinafter referred to as fixing time).

The control unit 6 changes the first distance DA according to the temperature of the nip N.

Immediately after the image forming device 1 is started, the temperature of the nip N is low. At this time, the amount of heat transferred to the toner on the sheet S is insufficient, and the toner is insufficiently melted. It takes time for the temperature of the nip N to rise to a predetermined temperature. For example, the predetermined temperature is the temperature of the nip N at which the toner is sufficiently melted. Therefore, it takes a long time to start the image forming process including the fixing process after starting the image forming device 1.

The control unit 6 determines whether or not the temperature of the nip N is less than the predetermined temperature. For example, the predetermined temperature is the temperature of the nip N at which the toner is sufficiently melted. When the temperature of the nip N is less than the predetermined temperature, the control unit 6 causes the first distance DA shorter than when the temperature of the nip N is equal to or higher than the predetermined temperature. As a result, the control unit 6 increases the fixing pressure.

As the fixing pressure is increased, the pressure acting on the toner on the sheet S is increased. The lack of the amount of heat transferred to the toner on the sheet S is compensated for by the increased pressure acting on the toner. As a result, the toner on the sheet S is sufficiently melted, and deterioration of image fixing quality is prevented. The control unit 6 can start the image forming process including the fixing process before the temperature of the nip N rises to a predetermined temperature. As a result, the time from when the image forming device 1 is started to when the image forming process is started is shortened.

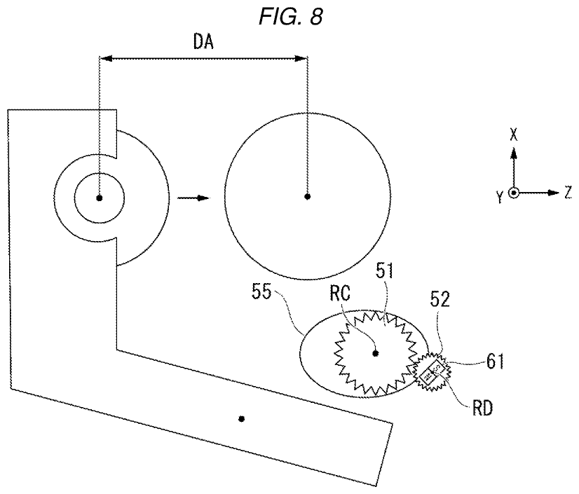

FIG. 8 is a schematic configuration diagram of the fixing device 30 in a modification of the embodiment. The modification differs from the embodiment in that the magnet 61 is mounted to a second gear 52. The modification will be described herein, while omitting the characteristics same as those of the embodiment.

The fixing device 30 includes the second gear 52 in addition to the first gear 51. The second gear 52 is rotatable around a fourth rotation axis RD in conjunction with the first gear 51. The fourth rotation axis RD is parallel to the Y direction. The second gear 52, along with the first gear 51, is installed in a transmission path of a rotational driving force from the motor to the cam 55. The second gear 52 may also be installed outside the transmission path of the rotational driving force. The number of teeth of the second gear 52 is less than that of the first gear 51. The angular range for the rotation of the second gear 52 is greater than that of the first gear 51. However, the second gear 52 is rotatable in the angular range of less than 360°.

The magnet 61 is mounted to the second gear 52. The magnet 61 is rotatable together with the second gear 52 around the fourth rotation axis RD. The polarization direction of the magnet 61 is the direction perpendicular to the fourth rotation axis RD. For example, the center of the magnet 61 in the polarization direction is located on the fourth rotation axis RD.

The TMR element 63 is disposed side by side with the magnet 61 in the Y direction. The TMR element 63 is disposed to cross the fourth rotation axis RD.

The angular range for the rotation of the second gear 52 is greater than the angular range for the rotation of the first gear 51, between the minimum value and the maximum value of the first distance DA. Since the magnet 61 is rotated together with the second gear 52, the resistance value of the TMR element 63 varies over a wide range. The control unit 6 receives the signal corresponding to the resistance value of the TMR element 63 from the sensor unit 60. The control unit 6 controls the fixing pressure based on the output signal from the sensor unit 60. As a result, the accuracy of fixing pressure control can be improved, and the image fixing quality can be improved.

The second gear 52 is rotatable in an angular range of less than 360°. The fixing pressure can be obtained immediately from the resistance value of the TMR element 63. It is not necessary to return the fixing device 30 to the initial state at the end or start of the image forming device 1. As a result, the power consumption of the image forming device 1 is reduced. In addition, the startup time of the image forming device 1 is shortened.

According to at least one embodiment described above, the heating roller 34, the pressure roller 31, and the sensor unit 60 are included. The heating roller 34 is rotatable around the first rotation axis RA. The pressure roller 31 is rotatable around the second rotation axis RB. The pressure roller 31 can contact and separate from the heating roller 34. The pressure roller 31 can contact the heating roller 34 to form the nip N. The distance between the first rotation axis RA and the second rotation axis RB is the first distance DA. The sensor unit 60 can output a signal corresponding to the first distance DA which is continuously changing. As a result, it is possible to improve the fixing quality of the image.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. A fixing device, comprising:
a first roller rotatable around a first rotation axis;
a second roller rotatable around a second rotation axis, of the second roller configured to contact the first roller so as to form a nip and separate from the first roller; and
a sensor configured to output a signal corresponding to a first distance which is continuously changing, the first distance extends between the first rotation axis and the second rotation axis.

2. The fixing device according to claim 1, further comprising:
a cam rotatable around a third rotation axis; and
an arm rotatable in conjunction with a rotation of the cam and rotatably supporting the second roller.

3. The fixing device according to claim 2,
wherein the sensor includes
a magnet rotatable together with the cam around the third rotation axis, and
a tunnel magneto resistance (TMR) element of which a tunnel magnetic resistance changes with rotation of the magnet.

4. The fixing device according to claim 2, further comprising:
a first gear rotatable together with the cam around the third rotation axis; and
a second gear rotatable around a fourth rotation axis in conjunction with the first gear and having fewer teeth than the first gear,
wherein the sensor includes
a magnet rotatable together with the second gear around the fourth rotation axis, and
a TMR element of which a tunnel magnetic resistance changes with the rotation of the magnet.

5. The fixing device according to claim 4,
wherein the second gear is rotatable in an angular range of less than 360°.

6. An image forming device, comprising:
an image forming component that forms an image;
the fixing device for fixing an image onto a sheet, the fixing device, comprising:
a first roller rotatable around a first rotation axis,
a second roller rotatable around a second rotation axis, of the second roller configured to contact the first roller so as to form a nip and separate from the first roller, and
a sensor configured to output a signal corresponding to a first distance which is continuously changing, the first distance extends between the first rotation axis and the second rotation axis; and
a controller that controls an operation of the fixing device.

7. The image forming device according to claim 6,
wherein the controller changes the first distance in accordance with a thickness of the sheet.

8. The image forming device according to claim 6,
wherein, when the sheet is a first sheet having a thickness equal to or greater than a predetermined value, the controller causes the first distance to be shorter than when the sheet is a second sheet having a thickness less than the predetermined value.

9. The image forming device according to claim 6,
wherein the controller changes the first distance in accordance with a temperature of the nip.

10. The image forming device according to claim 6,
wherein, when the temperature of the nip is less than a predetermined temperature, the controller causes the first distance to be shorter than when the temperature of the nip is equal to or higher than the predetermined temperature.

11. The image forming device according to claim 6, wherein the fixing device further comprises
a cam rotatable around a third rotation axis; and
an arm rotatable in conjunction with a rotation of the cam and rotatably supporting the second roller.

12. The image forming device according to claim 11,
wherein the sensor includes
a magnet rotatable together with the cam around the third rotation axis, and
a tunnel magneto resistance (TMR) element of which a tunnel magnetic resistance changes with rotation of the magnet.

13. The image forming device according to claim 11, further comprising:
a first gear rotatable together with the cam around the third rotation axis; and
a second gear rotatable around a fourth rotation axis in conjunction with the first gear and having fewer teeth than the first gear,
wherein the sensor includes
a magnet rotatable together with the second gear around the fourth rotation axis, and
a TMR element of which a tunnel magnetic resistance changes with the rotation of the magnet.

14. The image forming device according to claim 13,
wherein the second gear is rotatable in an angular range of less than 360°.

15. A method for an image forming device, comprising:
forming an image with an image forming component;
fixing the image onto a sheet with a fixing device comprising
rotating a first roller around a first rotation axis;
rotating a second roller around a second rotation axis;
contacting the second roller to the first roller so as to form a nip;
separating the second roller from the first roller;
and a sensor configured to outputting a signal corresponding to a first distance which is continuously changing, the first distance extends between the first rotation axis and the second rotation axis; and
controlling an operation of the fixing device.

16. The method according to claim 15, further comprising:
changing the first distance in accordance with a thickness of the sheet.

17. The method according to claim 15,
wherein, when the sheet is a first sheet having a thickness equal to or greater than a predetermined value,
the method further comprises causing the first distance to be shorter than when the sheet is a second sheet having a thickness less than the predetermined value.

18. The method according to claim 15, further comprising:
changing the first distance in accordance with a temperature of the nip.

19. The method according to claim 15,
wherein, when the temperature of the nip is less than a predetermined temperature,
the method further comprises causing the first distance to be shorter than when the temperature of the nip is equal to or higher than the predetermined temperature.

20. The method according to claim 15, further comprising:
rotating a cam around a third rotation axis; and
rotating an arm in conjunction with a rotation of the cam and rotatably supporting the second roller.
